(19) United States
(12) Patent Application Publication
(10) Pub. No.: US 2017/0271950 A1
(43) Pub. Date: Sep. 21, 2017

(54) STIRLING ENGINE HAVING ENERGY REGENERATION STRUCTURE USING WASTE HEAT RECOVERY

(71) Applicant: Jeju National University Industry-Academic Cooperation Foundation, Jeju-si Jeju-do (KR)

(72) Inventors: Won Gee CHUN, Seoul (KR); Kuan CHEN, Salt Lake City, UT (US); Nam Jin KIM, Incheon (KR); Yeong Min KIM, Seogwipo-si, Jeju-do (KR); Won Sik KIM, Jeju-si, Jeju-do (KR); Hae Jun JEONG, Jeju-si, Jeju-do (KR)

(21) Appl. No.: 15/315,813

(22) PCT Filed: Apr. 29, 2016
(86) PCT No.: PCT/KR2016/004517

§ 371 Date: Dec. 2, 2016

(30) Foreign Application Priority Data
Dec. 31, 2015 (KR) 10-2015-0190721

(51) Int. Cl. H02K 7/18; F02G 1/043

(52) U.S. Cl. CPC H02K 7/1815; F02G 1/043; F02G 2243/04

(57) ABSTRACT

The present invention is characterized in that the linear reciprocating motion of a displacer piston and a rod is converted into the rotating motion of a wheel body in accordance with a thermal change, which is generated by supplying waste heat from equipment to a portion of a displacer cylinder of a Stirling engine, in that magnets mounted to the wheel body, which is linked to the cylinder rod, are rotated in a circumferential direction to form a magnetic field and to consequently generate electric power in conjunction with power line coils provided around the magnets, in that the centrifugal force generated by the rotation of the wheel body enables the cylinder rod to more powerfully perform a linear motion, and in that a bottom plate, which is coupled to the lower portion of the cylinder body, is provided with heat conduction fins to increase the heat transfer area.

### TECHNICAL FIELD

The present invention relates to a Stirling engine having an energy regeneration structure using waste heat recovery, in which the linear reciprocating motion of a displacer piston and a rod is converted into the rotating motion of a wheel body in accordance with a thermal change (an isothermal change and an isovolumetric change), which is generated by immediately (directly) supplying waste heat from various kinds of industrial or household equipment to a portion of a displacer cylinder of a Stirling engine, in which magnets mounted to the wheel body, which is linked to the cylinder rod, are rotated in a circumferential direction to form a magnetic field and to consequently generate electric power in conjunction with power line coils provided around the magnets, in which the centrifugal force generated by the rotation of the wheel body enables the cylinder rod to more powerfully perform a linear motion, and in which a bottom plate, which is coupled to the lower portion of the cylinder body, is provided with heat conduction fins to increase the heat transfer area in order to improve heat transfer efficiency and to enhance heat transfer performance, whereby the heat absorption and heat dissipation performance of the cylinder is remarkably improved by the increased heat transfer area, making it easy to apply the Stirling engine to equipment that dissipates low-temperature waste heat.

### BACKGROUND ART

In general, a Stirling engine is a positive-displacement external combustion engine having a closed cycle, which is constructed such that a sealed cylinder having a piston is filled with a predetermined working gas (hydrogen, helium, etc.) so as to generate mechanical energy by driving the piston using the interaction of two isovolumetric changes, which are generated by heating or cooling the working gas from the outside, and two isothermal changes, which are subsequently generated by compression or expansion of the working gas.

The Stirling engine may have a structure such that a combustion chamber and a heating device such as a heating coil are disposed on one side of the cylinder and a heat-storage regenerator and a cooling coil are disposed on the outer periphery of the cylinder.

Further, the interior of the cylinder is divided into a high-temperature region and a low-temperature region by a predetermined piston.

Such a Stirling engine is known to have relatively high heat efficiency compared to other apparatuses for converting thermal energy into kinetic energy, and due to the characteristics of the external combustion engine, it is possible to freely select a fuel, emissions are clean, and the magnitude of emitted sound is very small.

Accordingly, there has been a demand for a power-generating device using a Stirling engine that is capable of being used for an engine of eco-friendly vehicles, a main engine or an auxiliary engine of ships, a multi-fuel engine for use in oil fields, aerospace equipment, household equipment, etc., and power-generating devices using a Stirling engine, which have various constructions for satisfying this demand, have been developed.

However, when a conventional Stirling engine receives heat from a low-temperature heat medium, it has problems of decreased heat transfer coefficient and deteriorated heat absorption and heat dissipation performance, and accordingly, research with an eye to overcoming these problems is being conducted.

### DISCLOSURE

### Technical Problem

The present invention has been made to solve the above problems with the prior art, and it is an object of the present invention to provide a Stirling engine having an energy regeneration structure using waste heat recovery, in which the linear reciprocating motion of a displacer piston and a rod is converted into the rotating motion of a wheel body in accordance with a thermal change (an isothermal change and an isovolumetric change), which is generated by immediately (directly) supplying waste heat from various kinds of industrial or household equipment to a portion of a displacer cylinder of a Stirling engine, in which magnets mounted to the wheel body, which is linked to the cylinder rod, are rotated in a circumferential direction to form a magnetic field and to consequently generate electric power in conjunction with power line coils provided around the magnets, in which the centrifugal force generated by the rotation of the wheel body enables the cylinder rod to more powerfully perform a linear motion, and in which a bottom plate, which is coupled to the lower portion of the cylinder body, is provided with heat conduction fins to increase the heat transfer area in order to improve heat transfer efficiency and to enhance heat transfer performance, whereby the heat absorption and heat dissipation performance of the cylinder is remarkably improved by the increased heat transfer area, making it easy to apply the Stirling engine to equipment that dissipates low-temperature waste heat.

### Technical Solution

In accordance with an aspect of the present invention, the above and other objects can be accomplished by the provision of a Stirling engine having an energy regeneration structure using waste heat recovery including a displacer cylinder 100 including a cylinder outer wall 110 having a housing configuration defining a space therein, a displacer cylinder bottom plate 120 and a displacer cylinder top plate 130 coupled to a lower portion and an upper portion of the cylinder outer wall 110 in order to perform a heating operation and a heat-reducing operation, respectively, and a displacer piston 150 provided between the displacer cylinder top plate 130 and the displacer cylinder bottom plate 120 in order to repeatedly move a middle displacer rod 140 up and down in response to an isovolumetric change and an isothermal change caused by compression and expansion occurring when air in the cylinder outer wall 110 is heated and cooled, the air heated through the displacer cylinder bottom plate 120 rising upwards via a flow path formed between an inner periphery of the cylinder outer wall 110 and an outer periphery of the middle displacer piston 140, and the heated air, having risen upwards, dissipating heat through the displacer cylinder top plate 130, and the air from which heat is dissipated pushing the displacer piston 150 downwards, and a power generation wheel 200 including a wheel body 210 configured to be rotated to generate centrifugal force in accordance with the up/down movement of the middle displacer rod 140, the centrifugal force of the wheel body 210 functioning to increase a propulsion force created when the middle displacer rod 140 is moved up and down in a linear reciprocating motion, and to be axially coupled to a main shaft 230 secured to an upper portion of a support body 220, and a plurality of magnets 240 arranged along an outer peripheral surface of the wheel body 210, when an interlocking link 250 hinged to one end of the main shaft 230 is pivoted by the middle displacer rod 140, the magnets 240 of the wheel body coupled to an opposite end of the main shaft 230 being rotated with respect to power line coils 260 arranged around the magnets 240, thereby forming a magnetic field and consequently generating electric power.

The displacer cylinder top plate 130 and the displacer cylinder bottom plate 120 may be configured to directly receive heat from a waste heat supply source having a surface contact direct-mounting structure, and may respectively have a plurality of heat conduction fins 131 and 121 formed on surfaces thereof facing an interior of the cylinder outer wall 110 in order to increase a heat transfer area.

The displacer piston 150 may have a plurality of slots 151 formed in surfaces thereof, the slots 151 being formed to have a shape corresponding to a shape of a cross-section of the heat conduction fins 131 and 121 of the displacer cylinder top plate 130 and the displacer cylinder bottom plate 120 so that the displacer piston is capable of being moved up and down by heating/cooling and compression/expansion of internal air in the cylinder outer wall 110 without interference with the heat conduction fins 131 and 121.

### Advantageous Effects

According to the above-described present invention, the linear reciprocating motion of a displacer piston and a rod is converted into the rotating motion of a wheel body in accordance with a thermal change (an isothermal change and an isovolumetric change), which is generated by immediately (directly) supplying waste heat from various kinds of industrial or household equipment to a portion of a displacer cylinder of a Stirling engine, and when magnets mounted to the wheel body, which is linked to the cylinder rod, are rotated in a circumferential direction, power line coils provided around the magnets form a magnetic field and consequently generate electric power.

Further, the centrifugal force generated by the rotation of the wheel body enables the cylinder rod to more powerfully perform a linear motion.

Furthermore, a bottom plate, which is coupled to the lower portion of the cylinder body, is provided with heat conduction fins to increase the heat transfer area in order to improve heat transfer efficiency and to enhance heat transfer performance, whereby the heat absorption and heat dissipation performance of the cylinder is remarkably improved by the increased heat transfer area, making it easy to apply the Stirling engine to equipment that dissipates low-temperature waste heat.

### DESCRIPTION OF DRAWINGS

FIG. 1 is a view illustrating a displacer cylinder of a Stirling engine according to the present invention;

FIGS. 2 and 3 are views illustrating the coupling state of the displacer cylinder according to the present invention;

FIGS. 4 and 5 are views illustrating a displacer cylinder top plate and a displacer cylinder bottom plate according to the present invention; FIGS. 6 to 9 are views illustrating a rubber ring and a heat insulation member according to the present invention; and

FIGS. 10 and 11 are views illustrating the coupling relationship between the displacer cylinder and a wheel according to the present invention.

[Description of Reference Numerals]

| | | | |
|---|---|---|---|
| 100 | Displacer Cylinder | 110 | Cylinder Outer Wall |
| 120 | Displacer Cylinder Bottom | 121, 131 | Heat Conduction Fin |
| | Plate | | |
| 130 | Displacer Cylinder Top | 140 | Displact Rod |
| | Plate | | |
| 150 | Displacer Piston | 151 | Slot |
| 200 | Power Generation Wheel | 210 | Wheel Body |
| 220 | Support Body | 230 | Main Shaft |
| 240 | Magnet | 250 | Interlocking Link |
| 260 | Power Line Coil | | |
| 400 | Rubber Ring | 500 | Heat Insulation Member |

### BEST MODE

The present invention comprises a displacer cylinder 100 including a cylinder outer wall 110 having a housing configuration defining a space therein, a displacer cylinder bottom plate 120 and a displacer cylinder top plate 130 coupled to a lower portion and an upper portion of the cylinder outer wall 110 in order to perform a heating operation and a heat-reducing operation, respectively, and a displacer piston 150 provided between the displacer cylinder top plate 130 and the displacer cylinder bottom plate 120 in order to repeatedly move a middle displacer rod 140 up and down in response to an isovolumetric change and an isothermal change caused by compression and expansion occurring when air in the cylinder outer wall 110 is heated and cooled, the air heated through the displacer cylinder bottom plate 120 rising upwards via a flow path formed between an inner periphery of the cylinder outer wall 110 and an outer periphery of the middle displacer piston 140, and the heated air, having risen upwards, dissipating heat through the displacer cylinder top plate 130, and the air from which heat is dissipated pushing the displacer cylinder 150 downwards; and a power generation wheel 200 including a wheel body 210 configured to be rotated to generate centrifugal force in accordance with the up/down movement of the middle displacer rod 140, the centrifugal force of the wheel body 210 functioning to increase a propulsion force created when the middle displacer rod 140 is moved up and down in a linear reciprocating motion, and to be axially coupled to a main shaft 230 secured to an upper portion of a support body 220, and a plurality of magnets 240 arranged along an outer peripheral surface of the wheel body 210, when an interlocking link 250 hinged to one end of the main shaft 230 is pivoted by the middle displacer rod 140, the magnets 240 of the wheel body coupled to an opposite end of the main shaft 230 being rotated with respect to power line coils 260 arranged around the magnets 240, thereby forming a magnetic field and consequently generating electric power.

### Mode for Invention

Hereinafter, the present invention will be described in more detail with reference to the attached drawings.

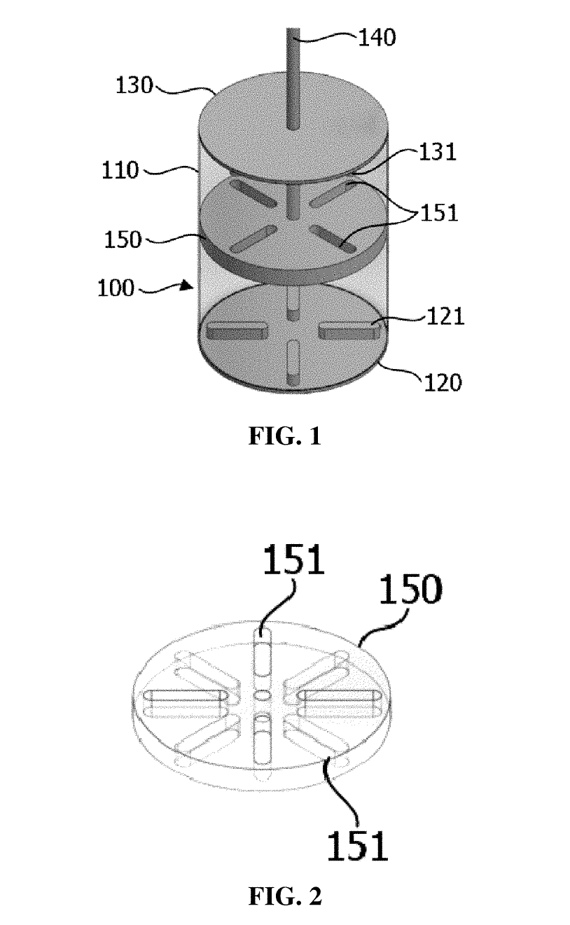

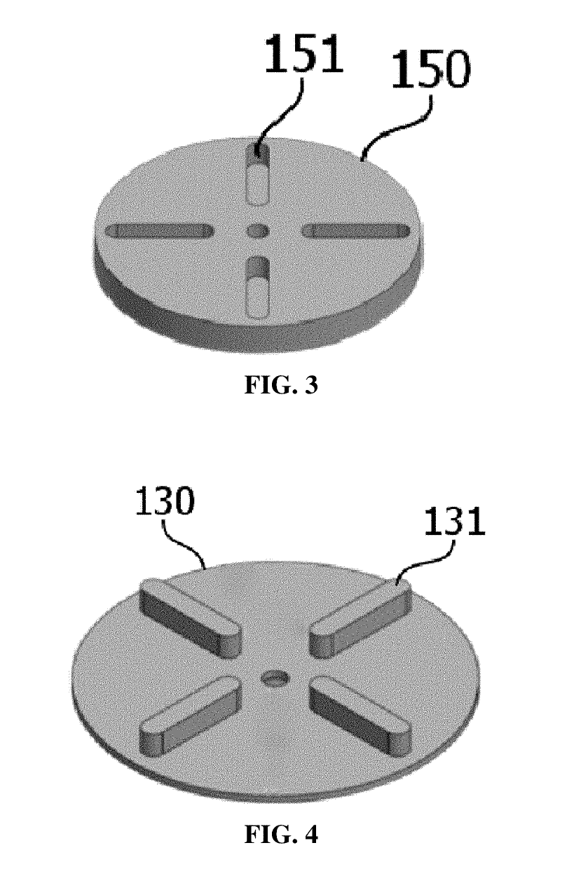

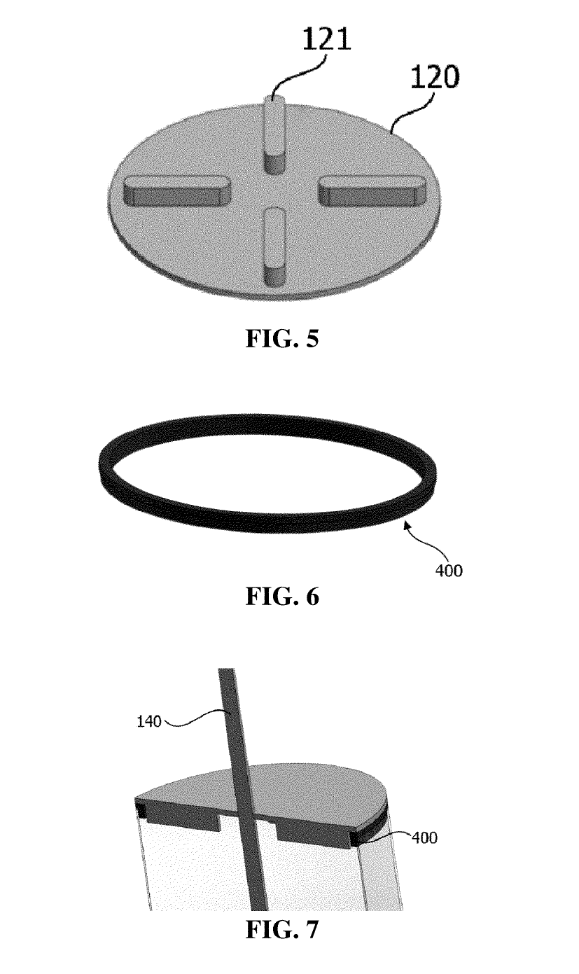

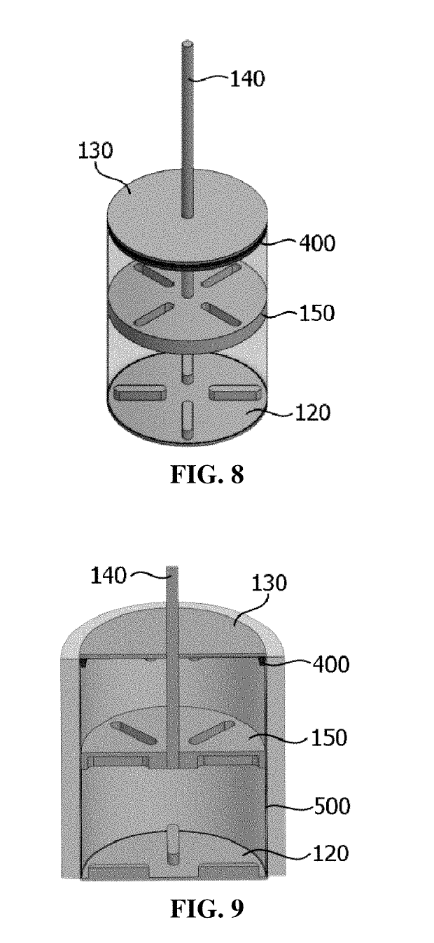

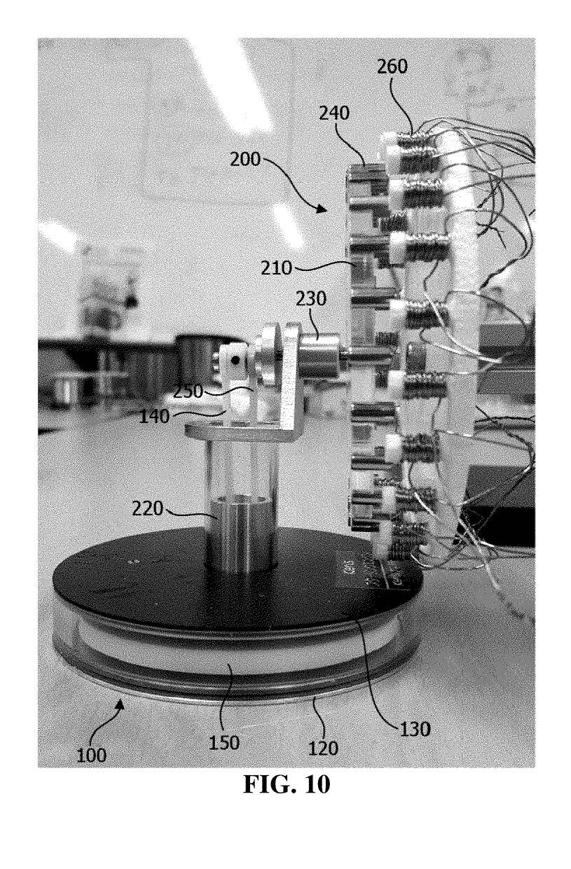

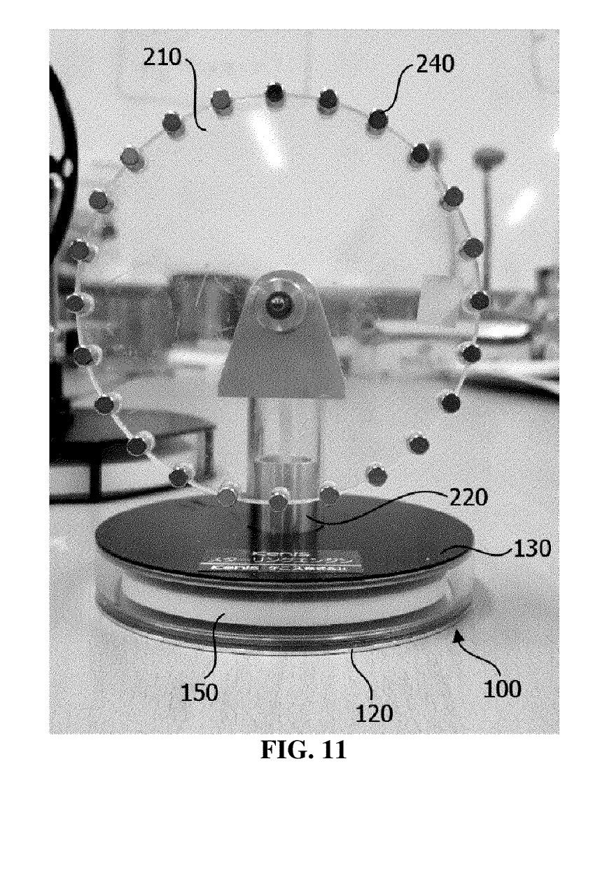

First, as shown in FIGS. 1 to 11, the present invention comprises a displacer cylinder 100 and a power generation wheel 200.

The displacer cylinder 100 includes a cylinder outer wall 110, which has a housing configuration defining a space therein, and a displacer cylinder bottom plate 120 and a displacer cylinder top plate 130, which are coupled to the lower portion and the upper portion of the cylinder outer wall 110 and through which the heating operation and the heat-reducing operation are achieved, respectively.

Provided is a displacer piston 150 between the displacer cylinder top plate 130 and the displacer cylinder bottom plate 120 in order to repeatedly move a middle displacer rod 140 up and down in response to an isovolumetric change and an isothermal change, which are caused by compression and expansion that occur when the air in the cylinder outer wall 110 is heated and cooled.

The air, which is heated through the displacer cylinder bottom plate 120, rises upwards via a flow path formed between the inner periphery of the cylinder outer wall 110 and the outer periphery of the middle displacer piston 150, and the heated air, having risen upwards, dissipates heat through the displacer cylinder top plate 130, and the resultant cooled air pushes the displacer piston 150 downwards.

That is, the displacer piston, which is provided between the displacer cylinder bottom plate and the displacer cylinder top plate, is configured to be repeatedly moved up and down in response to a thermal change, and the middle displacer rod, which is coupled to the displacer piston, is also configured to be moved up and down in a linear reciprocating motion.

The power generation wheel 200 includes a wheel body 210, which is configured to be rotated to generate centrifugal force in accordance with the up/down movement of the middle displacer rod 140, the centrifugal force of the wheel body 210 functioning to increase the propulsion force that is created when the middle displacer rod 140 is moved up and down in a linear reciprocating motion.

The wheel body 210 is axially coupled to a main shaft 230, which is secured to the upper portion of a support body 220.

The wheel body 210 is provided with a plurality of magnets 240 arranged along the outer peripheral surface thereof, and when an interlocking link 250, which is hinged to one end of the main shaft 230, is pivoted by the middle displacer rod 140, the magnets 240 of the wheel body coupled to the opposite end of the main shaft 230 are rotated with respect to power line coils 260, which are arranged around the magnets 240, thereby forming a magnetic field and consequently generating electric power.

The displacer cylinder top plate 130 and the displacer cylinder bottom plate 120 are configured to directly receive heat from a waste heat supply source, which has a surface contact direct-mounting structure, and respectively have a plurality of heat conduction fins 131 and 121 formed on the surfaces thereof that face the interior of the cylinder outer wall 110 in order to increase a heat transfer area.

It is preferable for the heat conduction fins to be embodied as any one of blocks or protrusions having a semicircular-shaped, triangular-shaped or polygonal-shaped section and a great number of needle-shaped projections.

In addition, the displacer piston 150 has a plurality of slots 151 formed in the surfaces thereof.

Specifically, the slots 151 are formed to have a shape corresponding to the shape of the cross-section of the heat conduction fins 131 and 121 of the displacer cylinder top plate 130 and the displacer cylinder bottom plate 120 so that the displacer piston can be moved up and down by heating/cooling and compression/expansion of the internal air in the cylinder outer wall 110 without interference with the heat conduction fins 131 and 121.

The heat conduction fins 131 of the displacer cylinder top plate 130 and the heat conduction fins 121 of the displacer cylinder bottom plate 120 are arranged to be offset from each other in order to further increase the heat transfer cross-sectional area.

Further, a rubber ring 400 is additionally inserted between the displacer cylinder top plate 130 and the top end of the cylinder outer wall 110 in order to secure heat insulation, thereby preventing the temperature of the heated air, from which heat is conducted through the outer wall of the cylinder body, from being increased.

Furthermore, a heat insulation member 500 is additionally provided along the inner peripheral surface of the cylinder outer wall 110 in order to prevent heat loss through the outer wall.

Although an exemplary embodiment of the present invention has been described for illustrative purposes, those skilled in the art will appreciate that various modifications, additions and substitutions are possible, without departing from the scope and the spirit of the invention as disclosed in the accompanying claims.

### INDUSTRIAL APPLICABILITY

According to the embodiment of the present invention, the linear reciprocating motion of a displacer piston and a rod is converted into the rotating motion of a wheel body in accordance with a thermal change (an isothermal change and an isovolumetric change), which is generated by immediately (directly) supplying waste heat from various kinds of industrial or household equipment to a portion of a displacer cylinder of a Stirling engine, and when magnets mounted to the wheel body, which is linked to the cylinder rod, are rotated in a circumferential direction, power line coils provided around the magnets form a magnetic field and consequently generate electric power.

1. A Stirling engine having an energy regeneration structure using waste heat recovery comprising:
a displacer cylinder (100) including a cylinder outer wall (110) having a housing configuration defining a space therein, a displacer cylinder bottom plate (120) and a displacer cylinder top plate (130) coupled to a lower portion and an upper portion of the cylinder outer wall (110) in order to perform a heating operation and a heat-reducing operation, respectively, and a displacer piston (150) provided between the displacer cylinder top plate (130) and the displacer cylinder bottom plate (120) in order to repeatedly move a middle displacer rod (140) up and down in response to an isovolumetric change and an isothermal change caused by compression and expansion occurring when air in the cylinder outer wall (110) is heated and cooled, the air heated through the displacer cylinder bottom plate (120) rising upwards via a flow path formed between an inner periphery of the cylinder outer wall (110) and an outer periphery of the displacer piston (150), and the heated air, having risen upwards, dissipating heat through the displacer cylinder top plate (130), and the air from which heat is dissipated pushing the displacer piston (150) downwards; and
a power generation wheel (200) including a wheel body (210) configured to be rotated to generate centrifugal force in accordance with the up/down movement of the middle displacer rod (140), the centrifugal force of the wheel body (210) functioning to increase a propulsion force created when the middle displacer rod (140) is moved up and down in a linear reciprocating motion, and to be axially coupled to a main shaft (230) secured to an upper portion of a support body (220), and a plurality of magnets (240) arranged along an outer peripheral surface of the wheel body (210), when an interlocking link (250) hinged to one end of the main shaft (230) is pivoted by the middle displacer rod (140), the magnets (240) of the wheel body coupled to an opposite end of the main shaft (230) being rotated with respect to power line coils (260) arranged around the magnets (240), thereby forming a magnetic field and consequently generating electric power.

2. The Stirling engine according to claim 1, wherein the displacer cylinder top plate (130) and the displacer cylinder bottom plate (120) are configured to directly receive heat from a waste heat supply source having a surface contact direct-mounting structure, and respectively have a plurality of heat conduction fins (131, 121) formed on surfaces thereof facing an interior of the cylinder outer wall (110) in order to increase a heat transfer area.

3. The Stirling engine according to claim 2, wherein the displacer piston (150) has a plurality of slots (151) formed in surfaces thereof, the slots (151) being formed to have a shape corresponding to a shape of a cross-section of the heat conduction fins (131, 121) of the displacer cylinder top plate (130) and the displacer cylinder bottom plate (120) so that the displacer piston is capable of being moved up and down by heating/cooling and compression/expansion of internal air in the cylinder outer wall (110) without interference with the heat conduction fins (131, 121).
